(19) United States
(12) Patent Application Publication
(10) Pub. No.: US 2014/0190079 A1
(43) Pub. Date: Jul. 10, 2014

(54) HYDROPONICS RESERVOIR WITH BOTTOM MOUNTED DRAINAGE SYSTEM

(71) Applicant: Erich Neola, Elk Grove, CA (US)

(72) Inventor: Erich Neola, Elk Grove, CA (US)

(21) Appl. No.: 13/736,909

(22) Filed: Jan. 8, 2013

(51) Int. Cl. A01G 31/02

(52) U.S. Cl. CPC A01G 31/02
USPC 47/62 R

(57) ABSTRACT

A hydroponics reservoir having a liquid reservoir, one or multiple drainage bowls attached to the bottom of the liquid reservoir, a pipe, a tube fitting, or a threaded fitting can be attached to each drainage bowl; the hydroponics reservoir can further comprise a bottom support strip, at least one reinforce strip, and at least one ducting hole wherein the pipe or the tube attached to the fittings can be fitted through the ducting hole.

### FIELD

The field of invention is a hydroponics reservoir with a bottom mounted drainage system including a drainage bowl and a pipe or tube fitting or other types of connection interface.

### SUMMARY OF THE INVENTION

The present invention discloses a hydroponics reservoir that can comprise one or multiple drainage systems located systematically and strategically at the bottom of the reservoir for maximum drainage effect. The disclosed hydroponics reservoir can be conveniently attached to an existing or specially designed sewage or recycling system allowing easily installation of the reservoir.

In one aspect, a hydroponics reservoir can comprise a liquid reservoir to supply liquid to a hydroponics planters basin, at least one drainage bowl, at least one drainage pipe, and a lid with predetermined number of openings; wherein the said liquid reservoir further comprises a drainage basin that is sloped toward the drainage bowl to let the water flow naturally toward the drainage bowl for optimal draining; wherein the said drainage bowl can be located at any position in the bottom of the liquid reservoir, and wherein the said drainage bowl further comprises a drainage hole; and wherein one end of the said drainage pipe is connected to the drainage hole in the said drainage bowl.

In another aspect, a hydroponics reservoir can comprise a liquid reservoir to supply liquid to a hydroponics planters basin, at least one drainage bowl, at least one tube fitting, at least one drainage tube and a lid with a predetermined number of openings; wherein the said liquid reservoir further comprises a drainage basin that is sloped toward the drainage bowl to let the water flow naturally toward the drainage bowl for optimal draining; wherein the said drainage bowl can be located at any position in the bottom of the liquid reservoir, and wherein the said drainage bowl further comprises a drainage hole; wherein one end of the said tube fitting is connected to the drainage hole in the said drainage bowl; and wherein the said drainage tube is attached to the tube fitting.

In a further aspect, a hydroponics reservoir can comprise a liquid reservoir to supply liquid to a hydroponics planters basin, at least one drainage bowl, at least one threaded fitting, and a lid with predetermined number of openings; wherein the said liquid reservoir further comprises a drainage basin that is sloped toward the drainage bowl to let the water flow naturally toward the drainage bowl for optimal draining; wherein the said drainage bowl can be located at any position in the bottom of the liquid reservoir, and wherein the said drainage bowl further comprises a drainage hole; and wherein one end of the said threaded fitting is connected to the drainage hole in the said drainage bowl.

In addition to the aspects and advantages or described in this summary, further aspects and advantages will become apparent by reference to the drawings and by reading the detailed description that follows.

### THE BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1A is a perspective view of the hydroponic reservoir wherein the drainage bowl is located in the middle of the drainage basin and wherein the drainage pipe is connected to a pump system, according to an embodiment;

FIG. 1B is a perspective view of the hydroponic reservoir wherein the reservoir is being used to supply liquid to a hydroponics planter basin, according to an embodiment;

FIG. 2 is bottom view of the hydroponics reservoir wherein the drainage bowl is located in the middle of the drainage basin and wherein the drainage pipe is fitted through the ducting hole, according to an embodiment.

FIG. 3 is a perspective view of the hydroponic reservoir wherein the drainage bowl is located in the middle of the drainage basin and wherein a tube fitting is attached to the drainage bowl, according to an embodiment;

FIG. 4 is bottom view of the hydroponics reservoir wherein the drainage bowl is located in the middle of the drainage basin and wherein a tube fitting is attached to the drainage bowl, according to an embodiment;

FIG. 5 is a perspective view of the hydroponic reservoir wherein the drainage bowl is located in the middle of the drainage basin and wherein a threaded fitting is attached to the drainage bowl, according to an embodiment;

FIG. 6 is bottom view of the hydroponics reservoir wherein the drainage bowl is located in the middle of the drainage basin and wherein a threaded fitting is attached to the drainage bowl, according to an embodiment;

FIG. 7 is a perspective view of the hydroponic reservoir wherein the drainage bowl is located in one corner of the drainage basin and wherein a tube fitting is attached to the drainage bowl, according to an embodiment;

FIG. 8 is bottom view of the hydroponics reservoir wherein the drainage bowl is located in one corner of the drainage basin and wherein a tube fitting is attached to the drainage bowl, according to an embodiment;

FIG. 9 is a perspective view of the hydroponic reservoir wherein the drainage bowl is located in one side of the drainage basin and wherein a pipe is attached to the drainage bowl, according to an embodiment;

FIG. 10 is bottom view of the hydroponics reservoir wherein the drainage bowl is located in one side of the drainage basin and wherein a pipe is attached to the drainage bowl, according to an embodiment;

FIG. 11 is bottom view of the hydroponics reservoir wherein two drainage bowls are installed in the drainage basin and wherein a pipe is attached to each of the drainage bowls, according to an embodiment.

### DETAILED DESCRIPTION

In the following detailed description, reference is made to the accompanying drawings that form a part hereof, and in which is shown by way of illustration specific implementations that may be practiced. These implementations are described in sufficient detail to enable those skilled in the art to practice the implementations, and it is to be understood that other implementations may be utilized and that logical, mechanical, electrical and other changes may be made without departing from the scope of the implementation. The following detailed description is, therefore, not to be taken in a limiting sense.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

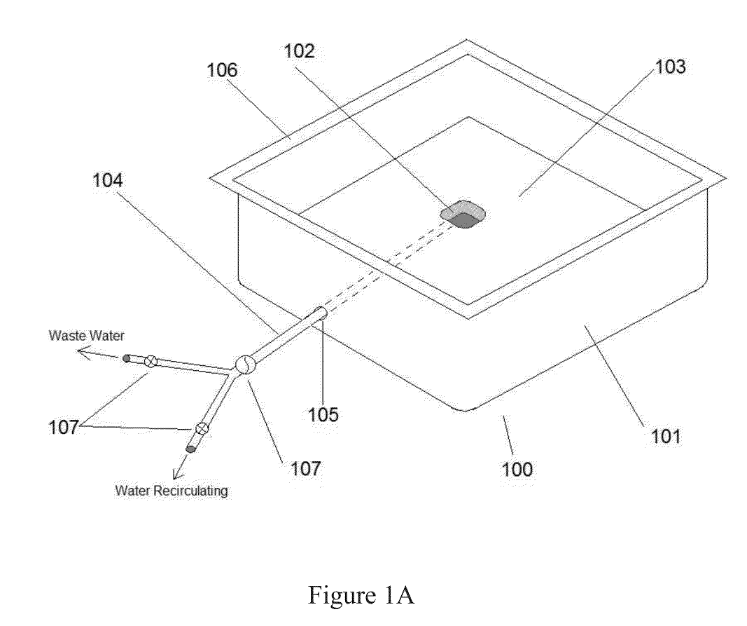

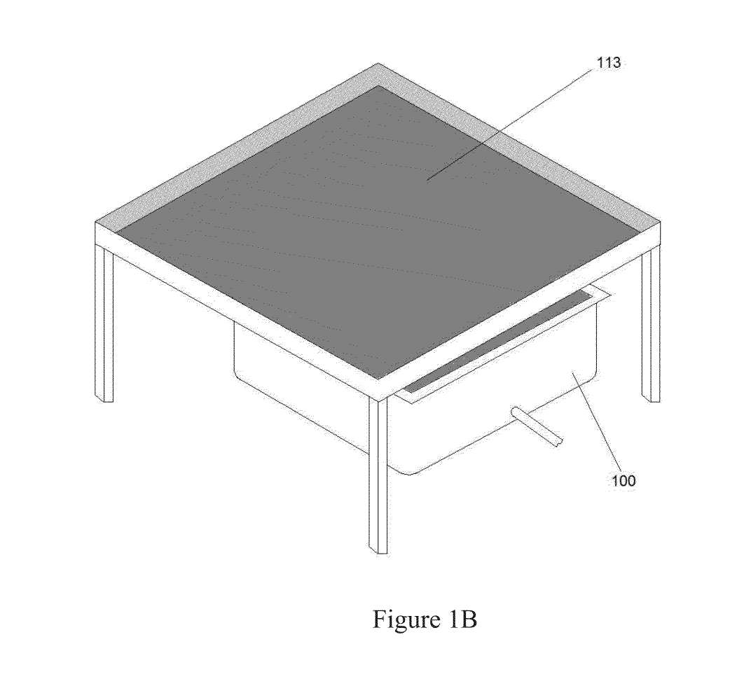

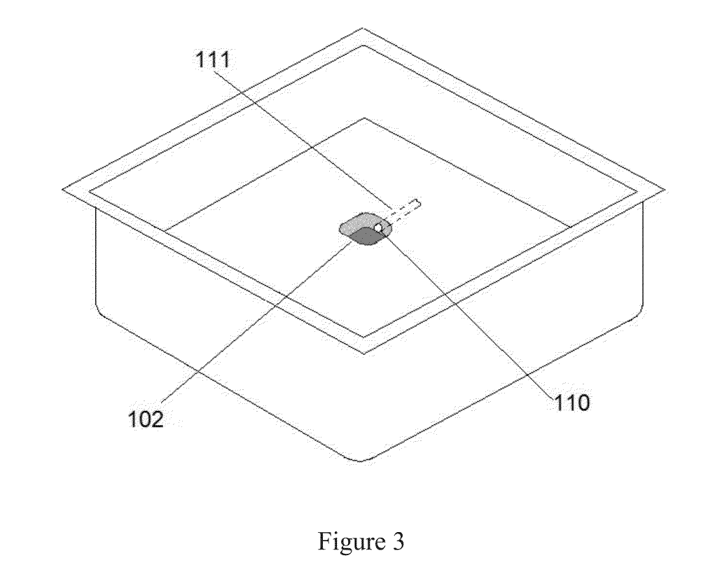

FIG. 1A is a perspective view of the hydroponic reservoir 100, according to one preferred embodiment. The hydroponic reservoir 100 can comprise a liquid reservoir 101, a drainage bowl 102, a drainage pipe 104, and a ducting hole 105. In this embodiment, the drainage bowl 102 is mounted in the middle of the drainage basin 103 of the liquid reservoir 101. There is a ducting hole 105 on the side of the liquid reservoir 101 below the surface of drainage basin 103. The surface of the liquid reservoir 101 is sloped so that the top of the drainage bowl 102 is the lowest point of the drainage basin to allow water to flow naturally into the drainage bowl 102. The drainage bowl 102 further comprises a drainage hole 110 (shown in FIG. 3) which is connected to one end of a drainage pipe 104. The drainage pipe is fitted through the ducting hole 105. The ducting hole 105 can be used as support for the drainage pipe 104 to prevent horizontal and vertical movement of the pipe. As FIG. 1 illustrates, one advantage of the hydroponics reservoir is that it can be easily installed with or connect to an existing or customized sewage or recycling system. In this embodiment, one end of the drainage pipe 105 can be connected to a pump 107 which can drain the liquid out of the liquid reservoir 101 quickly. The additional valves 107 can allow the liquid to be recycled back to the reservoir or to be drained into a sewage system. Additionally, a protruding edge 106 can be built around the top perimeter of the liquid reservoir to serve as a handle to increase the portability of the reservoir.

FIG. 1B is a perspective view of the hydroponic reservoir 100 wherein the reservoir is being used to supply liquid to a hydroponics planter basin 113. A hydroponics planter basin 113 is a container used to cultivate the plants. The hydroponics planter basin 113 can be a shallow container which holds predetermined depth of water. The plants are placed inside the hydroponics planter basin 113, and water or nutrient solution is supplied to the hydroponics planter basin 113. The water or nutrient solution can be stored the reservoir 100 and a tube, a pipe or other types of duct (not shown in drawing) can be used to deliver to the water from the reservoir 100 to the planter basin 113. The water or nutrient solution can also be drained back to the reservoir 100 from the planter basin 113.

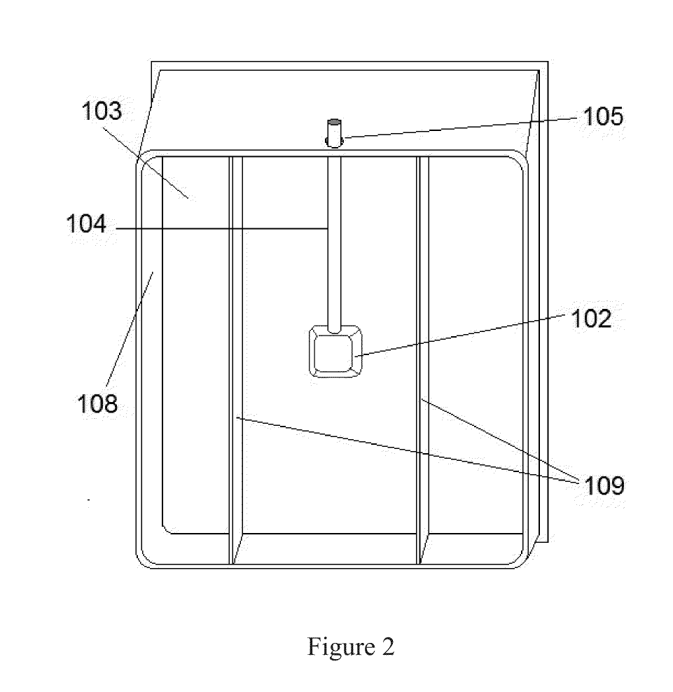

FIG. 2 is a bottom view of the hydroponic reservoir 100, according to one embodiment. The hydroponic reservoir can comprise a bottom support strip 108, and at least one reinforce strip 109. The bottom support strip 108 is attached to the reservoir 100 around the bottom perimeter of the liquid reservoir 101. By having a bottom support strip 108, a small amount of space will be created between the bottom of the drainage basin 103 and the surface on which the hydroponics reservoir 100 will be sitting. The space allows the drainage bowl 102 and the drainage pipe 104 to be installed without interfering with the stability of the reservoir. Since the liquid reservoir 101 will be filled with water, a large downward load will be placed on the bottom of the reservoir. To provide more support for the bottom, at least one reinforce strip 109 will be installed in the bottom of the reservoir. The reinforce strip 109 will be the same height as the bottom support strip 108 so that it can reach the surface on which the reservoir 100 is sitting.

As shown in FIG. 2, a ducting hole 105 can be cut out on the bottom support strip 108 such that the ducting hole 105 have approximately the same diameter as the drainage pipe 104. The drainage pipe 104 can then be fitted through the ducting, hole 105 and connected to an existing or customized sewage or recirculating system. The ducting hole 105 can also serve as a mounting and support element for the drainage pipe 104 that once the pipe is fitted through the ducting hole, lateral and vertical movement of the drainage pipe 104 is restricted by the tight fitting.

The drainage bowl 102 can be attached to the drainage basin 103 in many ways. In one preferred embodiment, the drainage bowl 102 can be molded as part the drainage basin 103. This type of attachment allows the liquid reservoir to be as water tight as possible because there will be no crevice between the drainage basin 103 and the drainage bowl 102. The drainage bowl 102 can also be attached to the liquid reservoir 101 through other chemical or mechanical means. For example, the drainage bowl 102 can be welded to the liquid reservoir 101 if they are both make of metals. For another example, the drainage bowl 102 can be glued to the liquid reservoir 103. For another example, the drainage bowl 102 can be nailed or screwed to the liquid reservoir. However, this kind of attachment may require further water-seal measures to keep the water from leaking.

FIG. 3 is a perspective view of the hydroponic reservoir 100, according to another preferred embodiment. The hydroponic reservoir 100 can comprise a liquid reservoir 101, a drainage bowl 102, tube fitting 104, and a ducting hole 105. In this embodiment, a tube fitting 111 is attached to the drainage hole 110 in the drainage bowl 102 instead of a drainage pipe 104. The tube fitting 111 can be fitted with a drainage tube (not shown in drawings), and the drainage tube will then be fitted through the ducting hole 105. A drainage tube has the advantage of flexibility comparing to a more rigid drainage pipe 104. Under certain circumstances, a drainage tube can be more convenient for the users. For example, the hydroponics reservoir users may want to run the drainage line through an extended distance in a non-straight line. A tube would be a much better choice than a pipe. Most water tubes are made of soft materials such as rubbers or plastics. Have a tube fitting 111 would allow for easy installation.

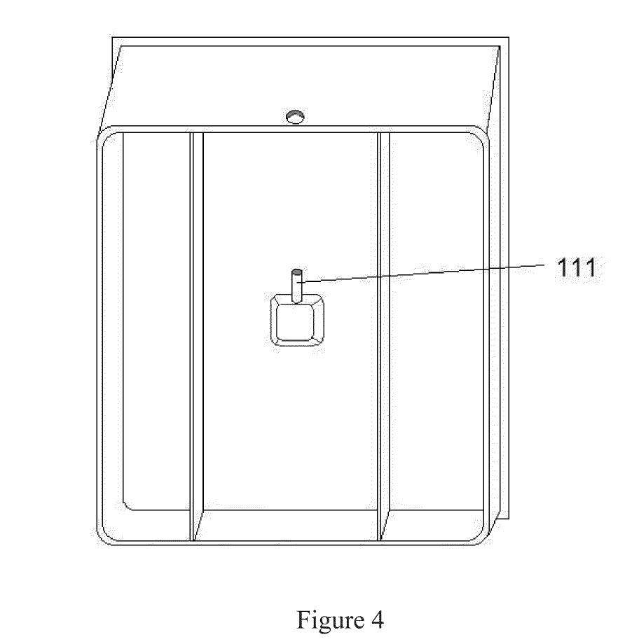

FIG. 4 is bottom view of the hydroponics reservoir 100 wherein the drainage bowl 102 located in the middle of the drainage basin and wherein a tube fitting 111 is attached to the drainage bowl 102, according to the embodiment. The fitting tube 111 can be a short solid tubular shaped connector attached to the drainage hole 110 on the drainage bowl 102.

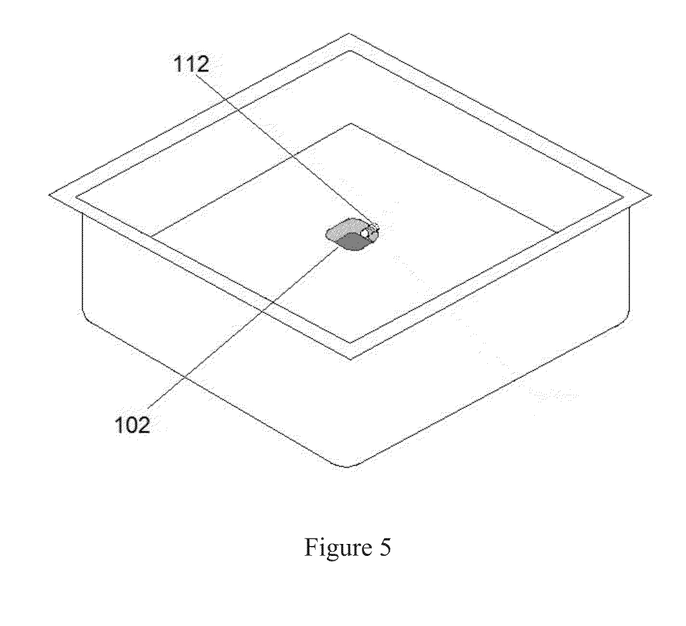

FIG. 5 is a perspective view of the hydroponic reservoir 100, according to another preferred embodiment. The hydroponic reservoir 100 can comprise a liquid reservoir 101, a drainage bowl 102, tube fitting 104, and a ducting hole 105. In this embodiment, a threaded fitting 112 is attached to the drainage hole 110 in the drainage bowl 102. The threaded fitting 112 can be internally-threaded (Not shown in figure or externally threaded. An internally-threaded pipe or externally threaded pipe can be connected to the threaded fitting 112 (not shown in drawings), and the threaded pipe can then be fitted through the ducting hole 105. With a threaded fitting 112, the user has more flexibility with the assembly and disassembly of the reservoir that the pipes can be easily installed and removed.

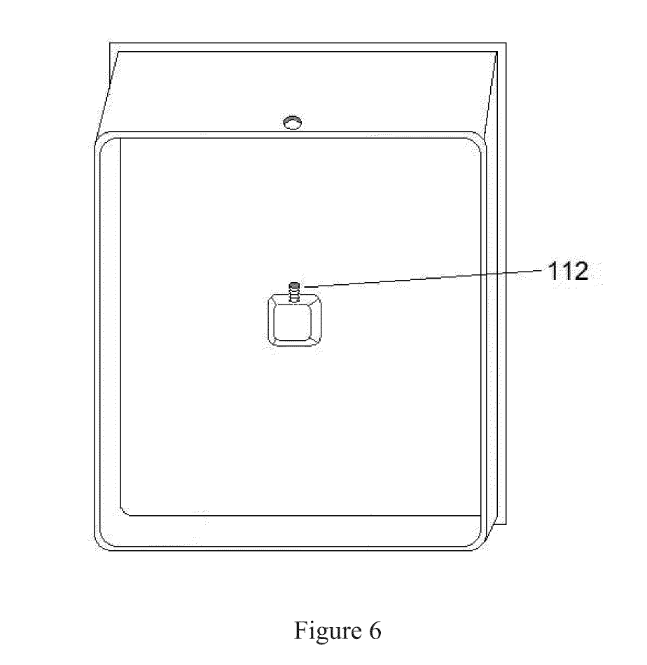

FIG. 6 is bottom view of the hydroponics reservoir 100 wherein the drainage bowl 102 located in the middle of the drainage basin and wherein a threaded fitting 112 is attached to the drainage bowl 102, according to the embodiment. The threaded fitting 112 can be a short solid tubular shaped connector attached to the drainage hole 110 on the drainage bowl 102 wherein the tubular shaped connector can be internally threaded or externally threaded.

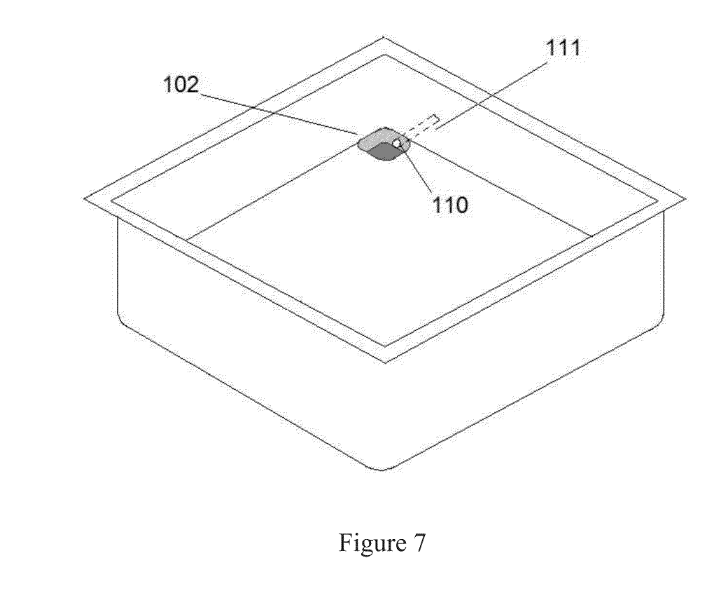

FIG. 7 is a perspective view of the hydroponic reservoir 100, according to another preferred embodiment. In this embodiment, the drainage bowl 102 is mounted in a corner of the drainage basin 103. In some circumstance, it may be more convenient for the user if the drainage bowl 102 is located in certain location on the drainage basin 103. For example, if the reservoir will be placed in a corner formed by two walls, and the inlet of the sewage system also locate at the corner. Having a corner-mounted drainage bowl 102 would provide convenience and is more aesthetically pleasing.

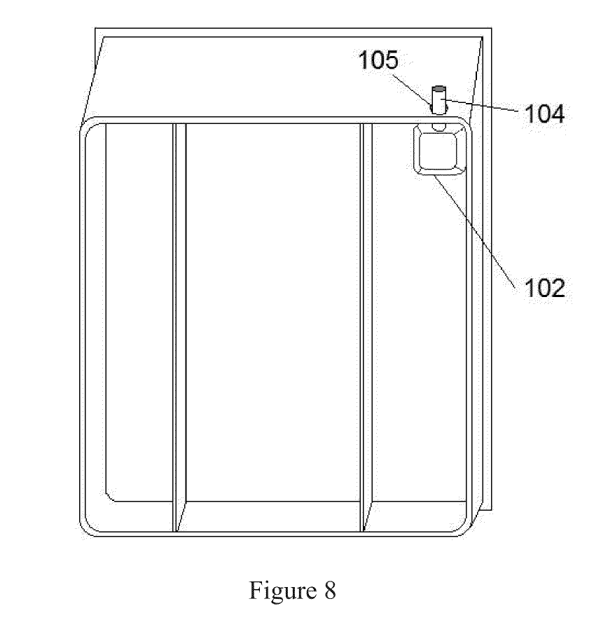

FIG. 8 is bottom view of the hydroponics reservoir 100 wherein the drainage bowl 102 located in one corner of the drainage basin, according to the embodiment. A pipe 104 or a tube fitting 111 can be attached to the drain bowl 102. There the tube fitting 111 or the drainage pipe 104 will be fitted directly into the ducting hole 105. There will be very little space between the ducting hole 105 and the drainage bowl.

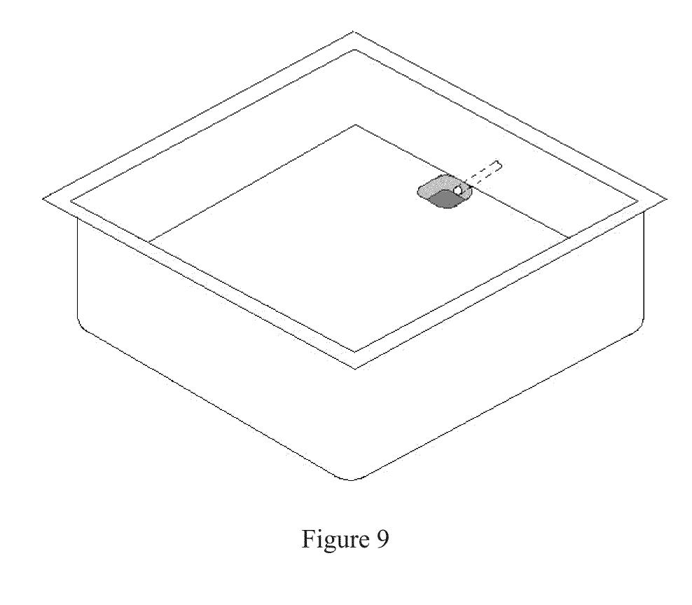

FIG. 9 is a perspective view of the hydroponic reservoir 100, according to another preferred embodiment. In this embodiment, the drainage bowl 102 is located in one side of the drainage basin 103. This embodiment is suitable for the reservoir 100 to be placed with one side against the wall when the sewage inlet (not shown) is located on the wall.

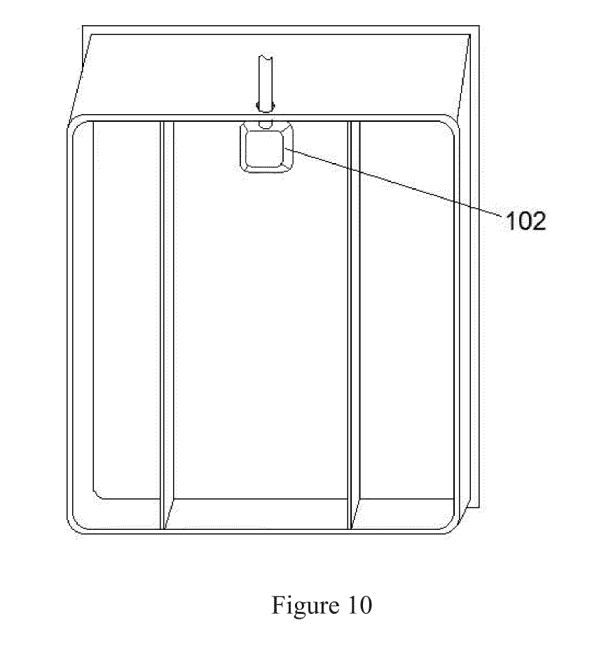

FIG. 10 is bottom view of the hydroponics reservoir 100 wherein the drainage bowl is located on one side of the drainage basin 103. A pipe 104 or a tube fitting 111 can be attached to the drain bowl 102. The tube fitting 111 or the drainage pipe 104 will be fitted directly into the ducting hole 105. There will be very little space between the ducting hole 105 and the drainage bowl 102.

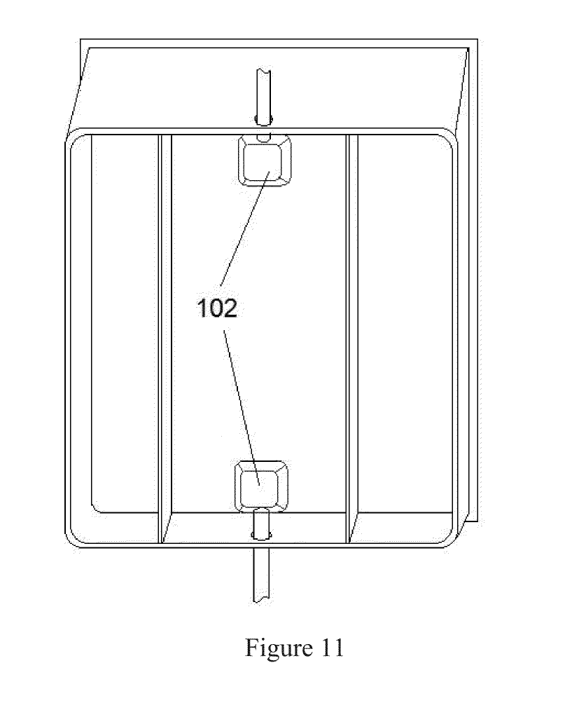

FIG. 11 is bottom view of the hydroponics reservoir 100 according to another preferred embodiment. In this embodiment, two drainage bowls 102 are installed in the drainage basin 103. The drainage basin 103 will be sloped in a way that the water will flow naturally toward each drainage bowl 102 in equal or unequal quantity. This embodiment allows the user to drain the water in two different directions thus resulting in faster and more effective drainage. In addition, the drainage bowl 102 can be mounted in any location at the bottom of the reservoir 100 as long as the drainage basin 103 is sloped in a way that water can be drained through both drainage bowls 102.

What is claimed is:

1. A hydroponics reservoir comprising:
a liquid reservoir to supply liquid to a hydroponics planters basin;
at least one drainage bowl; and
at least one drainage pipe;
wherein the said liquid reservoir further comprises a drainage basin that is sloped toward the drainage bowl to let the water flow naturally toward the drainage bowl for optimal draining;
wherein the said drainage bowl can be located at any position in the bottom of the liquid reservoir, and wherein the said drainage bowl further comprises a drainage hole; and
wherein one end of the said drainage pipe is connected to the drainage hole in the said drainage bowl.

2. The hydroponics reservoir as recited in claim 1, wherein the said drainage pipe is a metal pipe.

3. The hydroponics reservoir as recited in claim 1, wherein the said drainage pipe is PVC pipe.

4. The hydroponics reservoir as recited in claim 1, wherein the said drainage bowl is molded into the bottom of the liquid reservoir.

5. The hydroponics reservoir as recited in claim 1, wherein the said drainage bowl is attached to the said liquid reservoir by mechanical means.

6. The hydroponics reservoir as recited in claim 1, wherein the said liquid reservoir further comprises a bottom support strip and at least one ducting hole on the bottom support strip; and wherein the said drainage pipe is fitted through the ducting hole.

7. The hydroponics reservoir as recited in claim 1, wherein the said liquid reservoir further comprises at least one reinforce strip.

8. A hydroponics reservoir comprising:
a liquid reservoir to supply liquid to a hydroponics planters basin;
at least one drainage bowl;
at least one tube fitting; and
at east one drainage tube;
wherein the said liquid reservoir further comprises a drainage basin that is sloped toward the drainage bowl to let the water flow naturally toward the drainage bowl for optimal draining;
wherein the said drainage bowl can be located at any position in the bottom of the reservoir, and wherein the said drainage bowl further comprises a drainage hole;
wherein one end of the said tube fitting is connected to the drainage hole in the said drainage bowl; and
wherein the said drainage tube is attached to the tube fitting.

9. The hydroponics reservoir as recited in claim 8, wherein the said drainage bowl is molded into the bottom of the liquid reservoir.

10. The hydroponics reservoir as recited in claim 8, wherein the said drainage bowl is attached to the said liquid reservoir by mechanical means.

11. The hydroponics reservoir as recited in claim 8, wherein the said liquid reservoir further comprises a bottom support strip and at least one ducting hole on the bottom support strip; and wherein the said drainage tube is fitted through the ducting hole.

12. The hydroponics reservoir as recited in claim 8, wherein the said liquid reservoir further comprises at least one reinforce strip.

13. A hydroponics reservoir comprising:
a liquid reservoir to supply liquid to a hydroponics planters basin;
at least one drainage bowl;
at least one threaded fitting; and
a lid with predetermined number of openings;
wherein the said liquid reservoir further comprises a drainage basin that is sloped toward the drainage bowl to let the water flow naturally toward the drainage bowl for optimal draining;
wherein the said drainage bowl can be located at any position in the bottom of the liquid reservoir, and wherein the said drainage bowl further comprises a drainage hole; and
wherein one end of the said threaded fitting is connected to the drainage hole in the said drainage bowl.

14. The hydroponics reservoir as recited in claim 13, wherein the said drainage bowl is molded into the bottom of the liquid reservoir.

15. The hydroponics reservoir as recited in claim 13, wherein the said drainage bowl is attached to the said liquid reservoir by mechanical means.

16. The hydroponics reservoir as recited in claim 13, wherein the said threaded fitting is an internally-threaded fitting.

17. The hydroponics reservoir as recited in claim 13, wherein the said threaded fitting is an externally-threaded fitting.

18. The hydroponics reservoir as recited in claim 13, wherein a threaded pipe is attached to the said threaded fitting.

19. The hydroponics reservoir as recited in claim 18, wherein the said liquid reservoir further comprises a bottom support strip and at least one ducting hole on the bottom support strip; and wherein the said threaded pipe is fitted through the ducting hole.

20. The hydroponics reservoir as recited in claim 13, wherein the said liquid reservoir further comprises at least one reinforce strip.
